(19) United States
(12) Patent Application Publication
(10) Pub. No.: US 2006/0108179 A1
(43) Pub. Date: May 25, 2006

(54) Portable vehicle ladder system and method

(76) Inventor: Joseph Sieb, Willingboro, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 10/993,546

(22) Filed: Nov. 19, 2004

(51) Int. Cl. E06C 5/00

(52) U.S. Cl. 182/127

(57) ABSTRACT

A portable vehicle ladder system employs a hinged ladder with a slideable extension having moveable rungs to adjustably vary the length of the ladder. The ladder's hinges allow it to be used as a straight ladder or in a plurality of configurations, including as a table support. The ladder is removeably secured to the vehicle by an upper ladder support bracket mounted on the vehicle on which the ladder is placed. Also mounted on the vehicle is a lower ladder connection system, in which handle controlled latches secure the lower end of the ladder and permit the ladder to be unlatched and removed from the vehicle when it is to be used independently of the vehicle. The system can also be installed onto vehicles with existing, permanently mounted ladders.

### BACKGROUND OF THE INVENTION

The use of recreational vehicles, such as campers, vans, mobile motor homes, vehicle hauled camper compartments, and similarly sized vehicles, continue to enjoy wide popularity. The spaciousness of such vehicles, coupled with their mobility, make them ideal for road trips, camping, vacationing, and other such activities in which the advantages and convenience of large vehicles is required.

However, given the size, and especially the height of these vehicles, their roofs and upper regions, are inaccessible, absent some form of aid in climbing and descending. To address this need, a vertical ladder is affixed, usually to the rear of the vehicle, to allow individuals to reach the roof and upper areas when there is a need to check roof mounted equipment, to place, position or unload luggage, clean the area, or for any number of other reasons in which a ladder is useful. An example of this routinely used type ladder is seen in U.S. Pat. No. 4,151,895. While useful, however, such a ladder presents a danger, since it is routinely mounted above the vehicle's bumper. This invites injury when the user attempts to board or step down from the ladder.

Attempts have been made to address this hazard, but these have not fully solved the problem. For example, the system disclosed in U.S. Pat. No. 6,378,654 fails to provide the necessary lower step assistance, does not have an adjustable lower step section, and consists of an excessive number of moving parts which are subject to wear and breakage in outdoor environs.

Significantly, none of the prior vehicle mounted ladders are designed to be removable from the vehicle, to allow the ladder to be used independently of the vehicle. Vehicle mounted ladders are permanently secured to their vehicles and, as such, can merely service a very limited area of the vehicle. However, since ladders are helpful and often required in assisting with many different tasks in different locations, a vehicle owner who needs versatility in ladder usage is forced to carry an additional ladder which, of course, takes up storage space and adds weight.

### SUMMARY OF THE INVENTION

It is thus the object of the present invention to provide a portable vehicle ladder system which overcomes the limitations and advantages of prior such systems.

It is an object of the present invention to provide a portable vehicle ladder system with a portable ladder which has the versatility to be used when mounted on the vehicle and to be removed and used independently of the vehicle.

It is another object of the present invention to provide a portable vehicle ladder system with a portable ladder which is adjustably extendable, to permit safe and easy access to and egress from the ladder when mounted on a vehicle.

It is still another object of the present invention to provide a portable vehicle ladder system with a multi-purpose portable ladder which can be used on the vehicle and, when removed from the vehicle, can be used independently as a ladder in a plurality of configurations, both as a ladder and as a table support.

It is a further object of the present invention to provide a portable vehicle ladder system with a portable ladder which can be mounted on a vehicle in a plurality of ladder configurations.

It is another object of the present invention to provide a portable vehicle ladder system which, when mounted on the vehicle, provides easy and ready access to the roof and storage or luggage rack on the roof, for repairs and cleaning of the roof and upper regions of the vehicle, or for any purpose in which there is a need to work at a height.

It is still another object of the present invention to provide a portable vehicle ladder system which employs a single portable ladder which can be used both while mounted on the vehicle and independently of the vehicle, thus saving storage space or eliminating the need for the vehicle to carry additional weight.

It is a further object of the present invention to provide a portable vehicle ladder system which can be installed on vehicles with existing permanently mounted ladders.

These and other objects are accomplished by the present invention, a portable vehicle ladder system with a hinged ladder with a slideable extension having moveable rungs to adjustably vary the length of the ladder. The ladder's hinges allow it to be used as a straight ladder or in a plurality of configurations, including as a table support. The ladder is removeably secured to the vehicle by an upper ladder support bracket mounted on the vehicle on which the ladder is placed. Also mounted on the vehicle is a lower ladder connection system, in which handle controlled latches secure the lower end of the ladder and permit the ladder to be unlatched and removed from the vehicle when it is to be used independently of the vehicle. The system can also be installed onto vehicles with existing, permanently mounted ladders.

The novel features which are considered as characteristic of the invention are set forth in particular in the appended claims. The invention itself, however, both as to its design, construction, and use, together with the additional features and advantages thereof, are best understood upon review of the following detailed description with reference to the accompanying drawings.

### BRIEF DESCRIPTION OF THE DRAWINGS

FIG. 1 is a front view of the portable ladder of the system of the present invention.

FIG. 2 is a front view of the lower end of the portable ladder of the system of the present invention with its extension component in the full, upright position.

FIG. 3 is a cross-sectional view of the lower end of the portable ladder shown in FIG. 2.

FIG. 4 is front view of the lower end of the portable ladder of the system of the present invention with the extension component fully extended downward.

FIG. 5 is a cross-sectional view of the lower end of the portable ladder shown in FIG. 4.

FIG. 6 is a rear view of a vehicle employing the system of the present invention, without its portable ladder attached.

FIG. 7 is a rear view of the vehicle employing the system of the present invention with its portable ladder attached.

FIG. 8 is a partial isometric view of the right side of the lower ladder connection system of the present invention.

FIG. 9 is an internal, elevation view of the left side of the lower ladder connection system of the present invention.

FIG. 10 is a rear view of the lower ladder connection system of the present invention.

FIG. 11 is a partial elevation view of the system of the present invention with its portable ladder mounted to the rear of a vehicle.

FIG. 12 is a partial elevation view of the system of the present invention with its portable ladder mounted to a vehicle with a greater height than the vehicle shown in FIG. 10.

FIG. 13 is a partial elevation view of the ladder support frame of the system of the presenting invention mounted on the rear of a vehicle.

FIG. 14 is an exploded view of the elements used in the conversion of an existing ladder support frame.

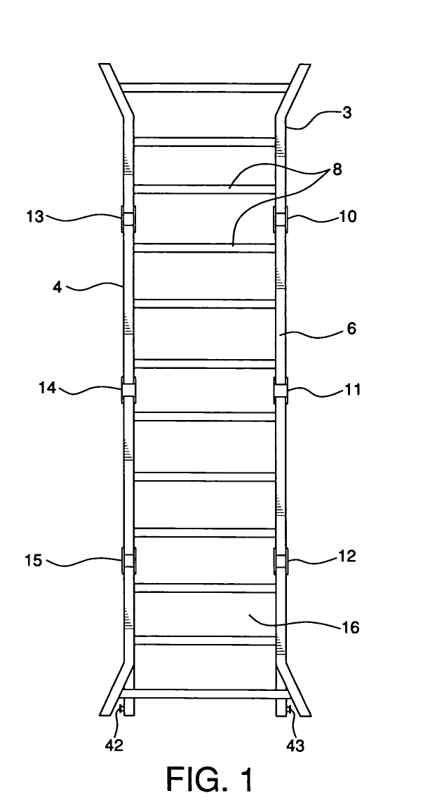

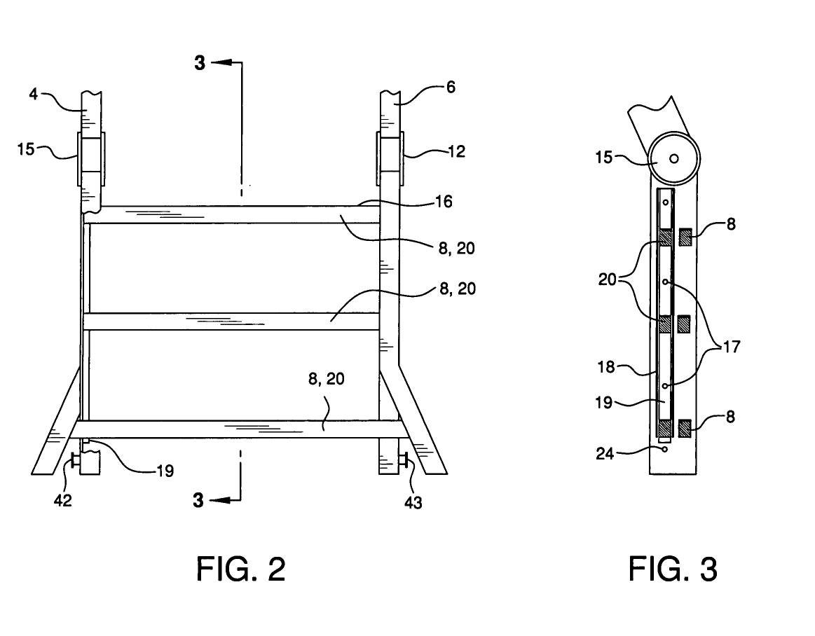

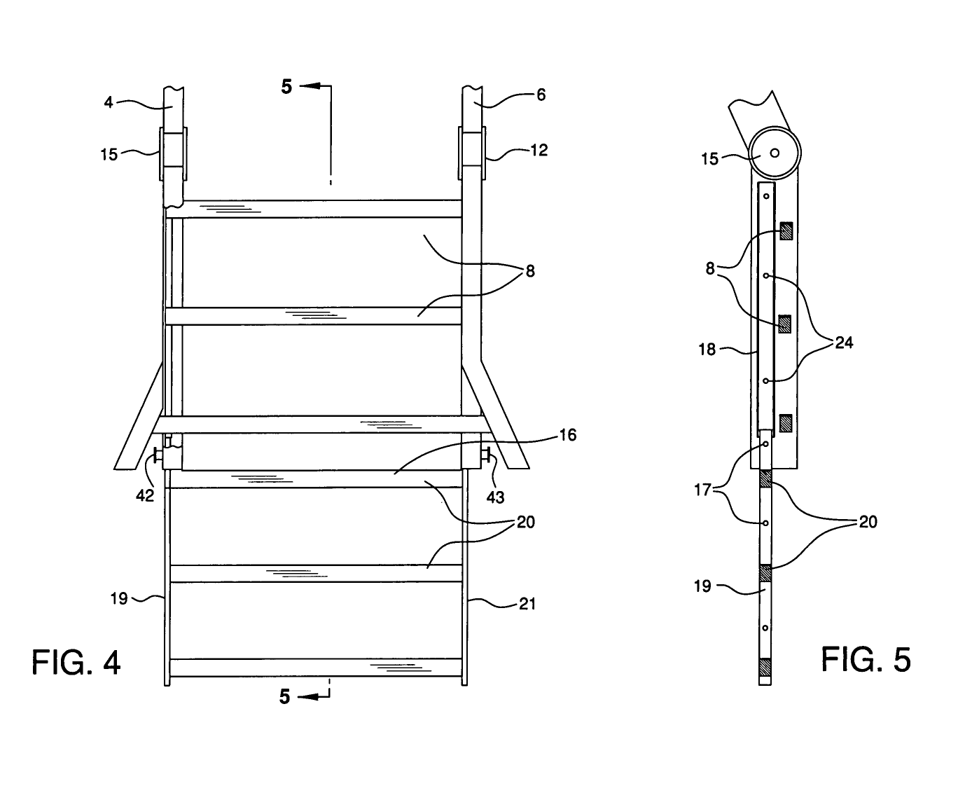

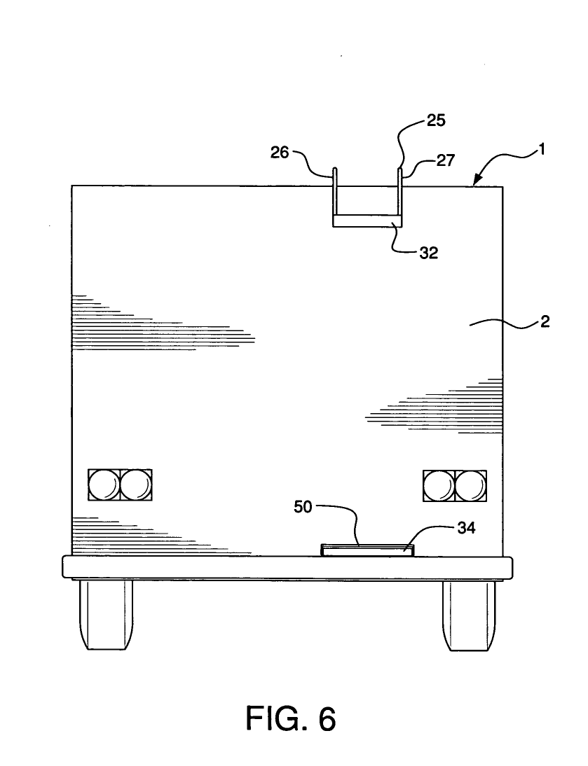

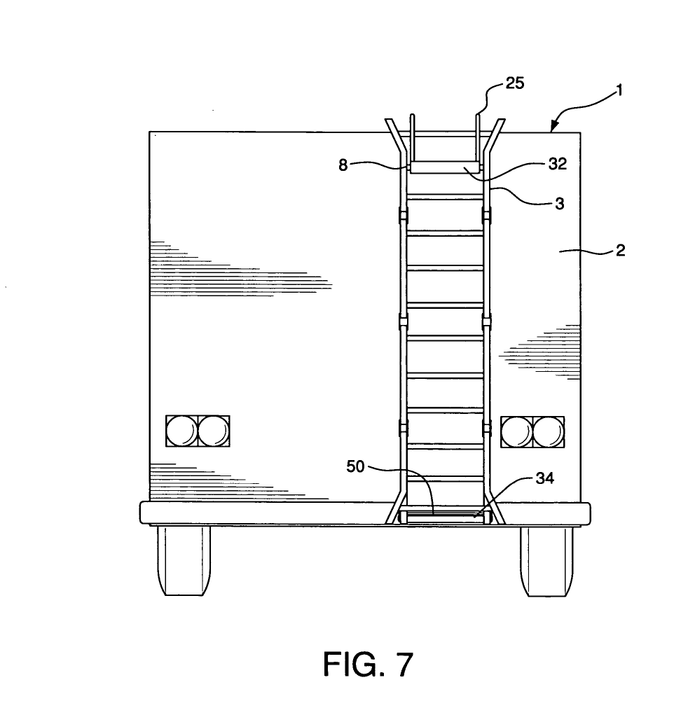

### DETAILED DESCRIPTION OF THE INVENTION

Vehicle 1 has a vertical surface 2 on which portable ladder 3 is removeably mounted. Ladder 3 comprises lateral ladder supports 4 and 6 permanently connected to immoveable ladder rungs 8. Hinges 10-15 are positioned on ladder supports 4 and 6 to provide ladder 3 with versatility, allowing it to be positioned in a plurality of different ladder configurations and to be used for a variety of different purposes, including as a table support.

Ladder 3 also comprises extension component 16, slideably moveable within channels located on the lower ends of ladder supports 4 and 6. Channel 18, on the interior surface of ladder support 4, is shown in FIG. 3. An identical channel is located on the interior surface of the lower end of ladder support 6, as seen in FIG. 5. Extension 16 also comprises rungs 20 which are connected to lateral extension supports 19 and 21. Extension 16 and its rungs 20 are slideably moveable in relation to ladder supports 4 and 6 and rungs 8.

Openings 17 in lateral extension supports 19 and 21 of extension 16 are configured to be aligned with openings 24 in lateral ladder supports 4. In this manner, pins, stop rings, or other known equivalent tab-type devices can be inserted into aligned openings 17 and 24 to adjustably maintain the height of extension 16 in relation to ladder supports 4 and 6. Identical height adjusting and maintaining openings and pins/tabs can be used on lateral ladder support 6 and extension support 21.

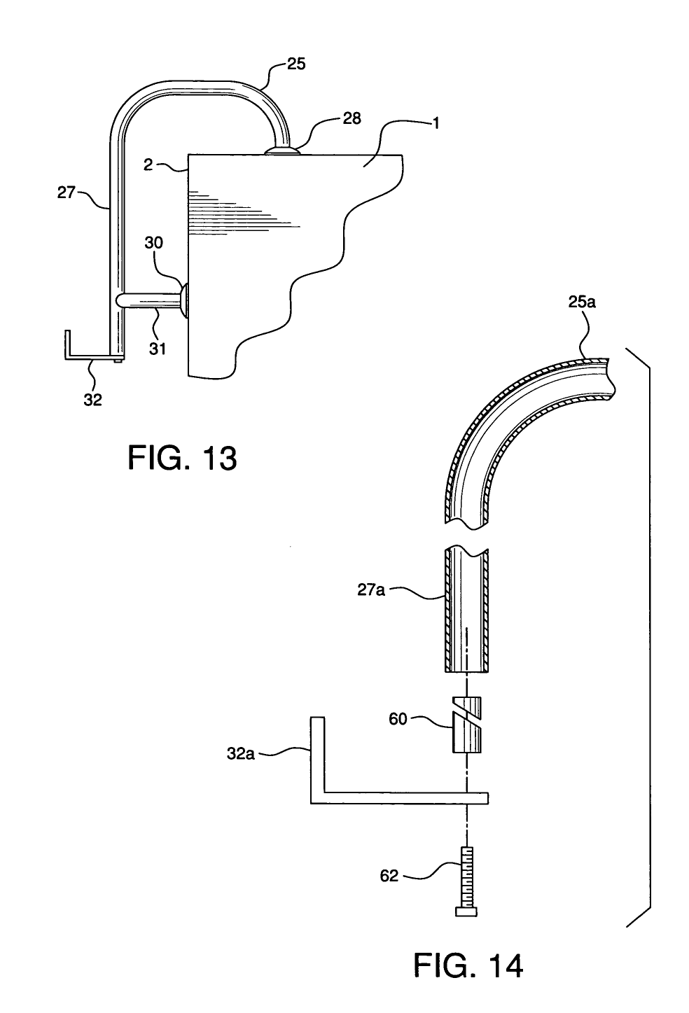

Ladder support frame 25, comprising tubular members 26 and 27, is secured to the upper region of vehicle 1 by roof mount 28 and vertical wall mount 30 and support 31, as shown in FIG. 13. Rung support bracket 32 is secured to the lower part of tubular members 26 and 27 of support frame 25 and is L-shaped in configuration to receive one of the rungs 8 of ladder 3.

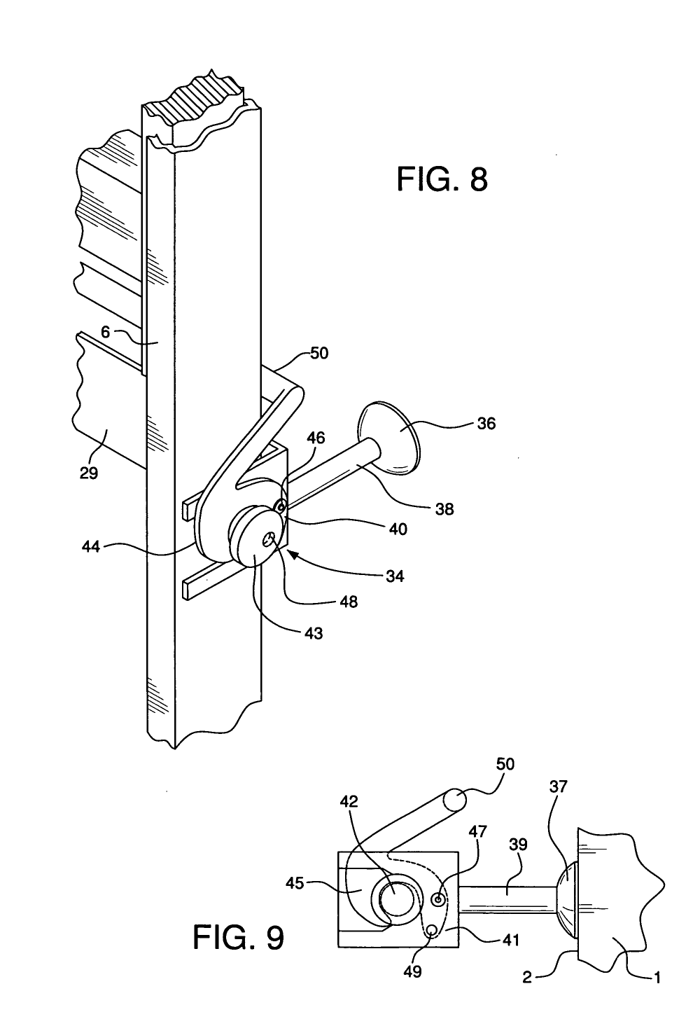

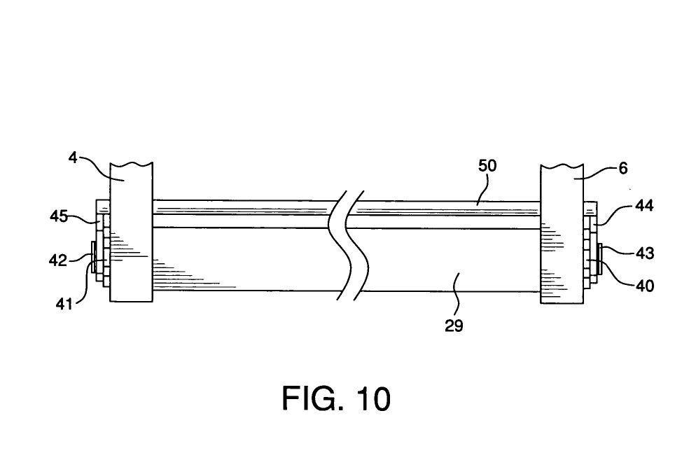

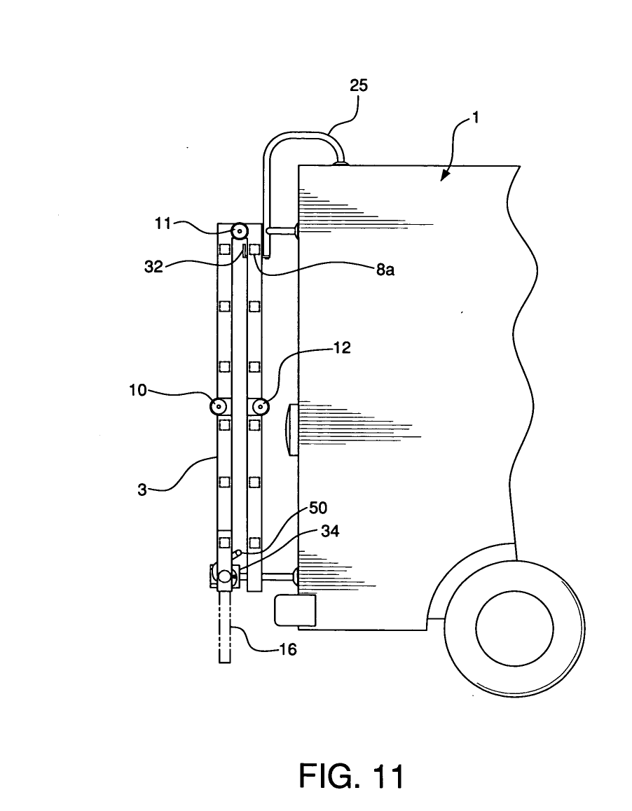

Lower ladder support system 34 is shown in FIGS. 8-10. FIG. 8 is a right side view of the support system. FIG. 9 shows a view of the left side of the system, facing the inward side of the bracket/latching arrangement. FIG. 10 is a rear view of the system. System 34 comprises vertical wall mounts 36 and 37 from which support bars 38 and 39 extend. Backing plate 29 interconnects ladder peg receiving brackets 40 and 41 which are connected to support bars 38 and 39. Bracket 40 is configured to receive ladder peg 43 and bracket 41 is configured to receive ladder peg 42. Pegs 42 and 43 extend outwardly from the lower end section of lateral ladder supports 4 and 6. Latches 44 and 45, pivoted at 46 and 47 respectively, are interconnected by handle 50. When in the closed position, latch 44 maintains peg 43 within bracket 40 and latch 45 maintains peg 42 within bracket 41. Spring loaded latches can also be used to ensure for an even more secure closure around pegs 42 and 43.

When it is desired to position and secure portable hinged ladder 3 to vehicle 1, the ladder is folded into the configuration shown in FIG. 11 and rung 8a is placed on bracket 32 of support frame 25. Pegs 42 and 43 of ladder 3 are pushed forward against latches 44 and 45, pivoting them open, thus allowing peg 42 at the lower end of ladder 3 to enter bracket 41 and peg 42 to enter bracket 42. Latches 44 and 45 are then pivoted close to maintain the lower end of ladder 3 in place.

Opening 48 in latch 44 is aligned with a corresponding opening within bracket 40 for the insertion of a lock or locking tab, to ensure for the integrity of the ladder-to-vehicle connection and for the security of ladder 3 while it is mounted on vehicle 1. Identical corresponding opening 49 within latch 45 and bracket 41 can be provided for added connection integrity and security.

When it is necessary to remove ladder 3 from vehicle 1, handle 50 is simply pushed forward, allowing latches 44 and 45 to pivot and open to release pegs 42 and 43. The lower end of ladder 3 can then be removed from lower ladder support system 34 and rung 8a lifted off bracket 32 of support frame 25. Ladder 3 can then be used independently of vehicle 1.

The presence of backing plate 29 provides added strength to the system when ladder 3 is being climbed while it is mounted on vehicle 1. Much of the inward compressive force against the ladder, exerted by the climbing user, is absorbed by backing plate 29.

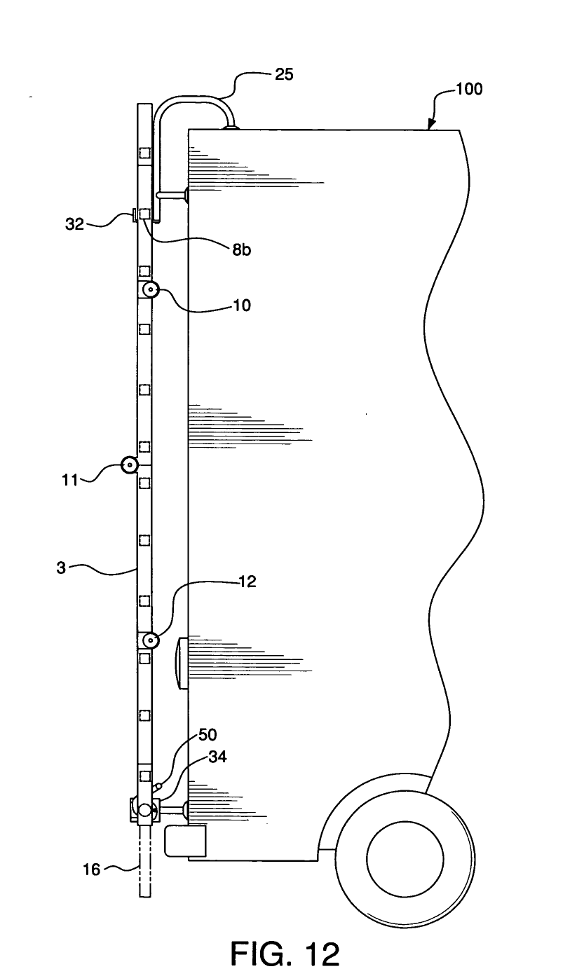

FIG. 12 shows ladder 3 being used on vehicle 100 of extended height. In this situation, ladder 3 is extended to its full vertical length and its rung 8b is hung on bracket 32 of support frame 25. The lower end of ladder is connected to lower ladder support system 34 as previously described. The hinged versatility of ladder 3 allows it to be positioned in a plurality of configurations, not only for ladder use independently of the vehicle, but also for mounting on the vehicle. And, as a result, the invention is not to be considered restricted to the ladder-to-vehicle mounting configurations described herein. The ladder may be positioned in any convenient configuration, depending on the height of the vehicle on which it is to be attached.

It is also anticipated that the means to secure pegs 42 and 43 within lower ladder support system 34 can be by any known latch type devices and the invention is not to be considered limited to the latching system described herein.

Provision is also made to convert vehicles with existing permanently mounted ladders with the novel, portable vehicle ladder system of the herein described invention. Most existing vehicle mounted ladders are permanently mounted at their upper ends to the roofs of their respective vehicles by downwardly extending tubular members, similar to members 26 and 27 of support frame 25 of the present invention. The tubular members actually form the upper end of the ladder, which then extends down along the vertical back wall of the vehicle. A representative vehicle ladder system is shown in U.S. Pat. No. 4,151,895. Conversion of such use-restricted ladders to the novel system of the present invention is accomplished, as seen in FIG. 13, by cutting or severing tubular support member 27a of an existing ladder, at an upper location, just above where the existing ladder begins or just beneath the wall mount of the ladder support frame. The other supporting tubular member is similarly cut or severed. Rung support bracket 32a is then connected to tubular member 27a and the other supporting tubular member, by means of expandable nut 60 and bolt 62 combination. It is contemplated that expandable nut 60 be adjustable, as is known in the art, so as to be compatible with the internal diameter of any tubular member 27a. In this manner, a tight and secure connection can be made to maintain bracket 32a in position, regardless of the diameter of the tubular member being converted.

To complete the conversion, a new lower support system 34, including wall mounts 36 and 37 with support bars 38 and 39 and backing plate 29 connected to brackets 40 and 41, latches 44 and 45, and handle 50, are then attached to the lower region of vehicle 1. The conversion of an existing vehicle with permanently mounted ladder is thereby completed and the portable vehicle ladder described herein can then be removeably attached to the vehicle.

Certain novel features and components of this invention are disclosed in detail in order to make the invention clear in at least one form thereafter. However, it is to be clearly understood that the invention as disclosed is not necessarily limited to exact form and details as disclosed since it is apparent that various modifications and changes may be made without departing from the spirit of the invention.

1. A system for removeably securing a portable ladder to a substantially vertical surface of a vehicle, said system comprising:
(a) a portable ladder with a plurality of immoveable ladder rungs, a plurality of moveable ladder rungs, and means to extend the moveable rungs in relation to the immoveable rungs;
(b) a vehicle with a substantially vertical surface, said vehicle having mounting means to position and removeably support the ladder in a spaced apart, substantially vertical position with respect to the surface; and
(c) operable ladder connection means to secure the ladder in said vertical position, whereby when the ladder is secured by the connection means it is attached to the vehicle for use on the vehicle and when it is not secured by the connection means, it is removeable from the mounting means to permit its use independently of the vehicle.

2. The system as in claim 1 further comprising stop means to control the degree of extension of the moveable rungs in relation to the immoveable rungs and to secure the moveable rungs in relation to the immoveable rungs.

3. The system as in claim 1 in which the portable ladder further comprises lateral ladder supports and the means to extend the moveable rungs in relation to the immoveable rungs comprises channels located on the lateral ladder supports.

4. The system as in claim 3 wherein the moveable rungs are slideably mounted within the channels.

5. The system as in claim 4 further comprising stop means to control the degree of extension of the moveable rungs within the channels and to secure the moveable rungs within the channels.

6. The system as in claim 1 in which the connection means comprises pegs extending from the ladder.

7. The system as in claim 1 in which the connection means comprises operable latch means for securing the ladder to and releasing it from the vehicle.

8. The system as in claim 7 in which the connection means further comprises peg means extending from the ladder, said peg means being insertable into the latch means for securing the ladder to the vehicle.

9. The system as in claim 1 wherein the connection means comprises dual latches interconnected and controlled for opening and closing by a handle.

10. The system as in claim 7 wherein the latch means comprises dual latches interconnected and controlled for opening and closing by a handle.

11. The system as in claim 9 wherein the connection means further comprises two pegs extending from the ladder, each peg being insertable into one of the dual latches.

12. The system as in claim 1 wherein the connection means comprises means to lock the connection means when the ladder is secured by the connection means.

13. The system as in claim 8 wherein the latch means comprises dual latches interconnected and controlled for opening and closing by a handle and the peg means comprises two pegs insertable into the dual latches for securing the ladder.

14. The system as in claim 1 wherein the mounting means extends outwardly from the vehicle to position and removeably support the ladder.

15. The system as in claim 1 wherein the mounting means comprises bracket means for positioning and removeably supporting the ladder.

16. The system as in claim 14 wherein the mounting means comprises bracket means for positioning and removeable supporting the ladder.

17. The system as in claim 1 wherein the ladder further comprises hinge means for changing the shape of the ladder and positioning it in a plurality of configurations.

18. The system as in claim 17 wherein the ladder can be removeably secured to the vertical surface of the vehicle in the plurality of configurations.

19. A system for removeably securing a portable ladder to a substantially vertical surface of a vehicle, said system comprising:
(a) a portable ladder with a plurality of immoveable ladder rungs connected between lateral ladder supports, and a ladder extension, slideably mounted in relation to the immoveable ladder rungs of the ladder supports;
(b) a vehicle with a substantially vertical surface, said vehicle having mounting means to position and removeably support the ladder in a spaced apart, substantially vertical position with respect to the wall surface; and
(c) operable ladder connection means to secure the ladder in said vertical position, whereby when the ladder is secured by the connection means it is attached to the vehicle for use on the vehicle and when it is not secured by the connection means, it is removable from the mounting means to permit its uses independently of the vehicle.

20. The system as in claim 19 further comprising stop means to control the degree in which the ladder extension is extended in relation to the immoveable rungs and to secure the extension in relation to the immoveable rungs.

21. The system as in claim 19 in which the portable ladder further comprises lateral ladder supports comprising channels.

22. The system as in claim 21 wherein the ladder extension has rungs and is slideably mounted within the channels.

23. The system as in claim 19 in which the connection means comprises pegs extending from the ladder

24. The system as in claim 19 in which the connection means comprises operable latch means for securing the ladder to and releasing it from the vehicle.

25. The system as in claim 24 in which the connection means further comprises peg means extending from the ladder, said peg means being insertable into the latch means for securing the ladder to the vehicle.

26. The system as in claim 19 wherein the connection means comprises dual latches interconnected and controlled for opening and closing by a handle.

27. The system as in claim 24 wherein the latch means comprises dual latches interconnected and controlled for opening and closing by a handle.

28. The system as in claim 26 wherein the connection means further comprises two pegs extending from the ladder, each peg being insertable into one of the dual latches.

29. The system as in claim 19 wherein the connection mans comprises means to lock the connection means when the ladder is secured b the connection means.

30. The system as in claim 25 wherein the latch means comprises dual latches interconnected and controlled for opening and closing by a handle and the peg means comprises two pegs insertable into the dual latches for securing the ladder.

31. The system as in claim 19 wherein the mounting means extends outwardly from the vehicle to position and removeably support the ladder.

32. The system as in claim 19 wherein the mounting means comprises bracket means for positioning and removeably supporting the ladder.

33. The system as in claim 31 wherein the mounting means comprises bracket means for positioning and removeable supporting the ladder.

34. The system as in claim 19 wherein the ladder further comprises hinge means for changing the shape of the ladder and positioning it in a plurality of configurations.

35. The system as in claim 34 wherein the ladder can be removeably secured to the vertical surface of the vehicle in the plurality of configurations.

36. A portable ladder which is to be removeably secured to a substantially vertical surface of a vehicle, said ladder comprising:
(a) a plurality of immoveable ladder rungs connected between lateral ladder supports;
(b) a plurality of moveable rungs connected to the lateral ladder supports;
(c) means to extend the moveable rungs in relation to the immoveable rungs;
(d) stop means to control the degree of extension of the moveable rungs in relation to the immoveable rungs and to secure the moveable rungs in relation the immoveable rungs; and
(e) connection means extending from the lateral ladder supports to secure the ladder to a substantially vertical surface of a vehicle in a substantially vertical position, whereby when the ladder is secured by the connection means it is attached to the vehicle for use on the vehicle and when it is not secured by the connection means, it is removeable from the vehicle to permit its use independently of the vehicle.

37. The portable ladder as in claim 36 wherein the means to extend the moveable rungs in relation to the immoveable rungs comprises channels located on the lateral ladder supports.

38. The portable ladder as in claim 37 wherein the moveable rungs are slideably mounted within the channels.

39. The portable ladder as in claim 36 wherein the connection means comprises pegs extending from the lateral ladder supports, said pegs being insertable into latch means on the vehicle for securing the ladder to the vehicle.

40. The portable ladder as in claim 36 wherein the ladder further comprises hinge means on the lateral ladder supports for changing the shape of the ladder and positioning it in a plurality of configurations.

41. The portable ladder as in claim 40 wherein the ladder can be removeably secured in a substantially vertical position, in spaced relation to the vertical surface of the vehicle in the plurality of configurations.

42. A method for removeably securing a portable ladder to a substantially vertical surface of a vehicle having an existing, permanently connected, vehicle mounted ladder with rungs extending between lateral ladder supports, said method comprising the steps of:
(a) severing the lateral ladder supports above the upper most rung of the vehicle mounted ladder;
(b) removing the vehicle mounted ladder;
(c) providing a portable ladder support bracket;
(d) positioning the portable ladder support bracket directly beneath the severed ends of the lateral supports;
(e) connecting the bracket to the lateral supports;
(f) providing a portable ladder connection system;
(g) attaching the portable ladder connection system to a lower region of the vertical surface of the vehicle; and
(h) placing the portable ladder on the support bracket.
